(19) United States
(12) Patent Application Publication
(10) Pub. No.: US 2025/0378026 A1
(43) Pub. Date: Dec. 11, 2025

(54) TECHNIQUES FOR TRANSMITTING LOGICAL-TO-PHYSICAL ADDRESS MAPPING TO A HOST SYSTEM

(71) Applicant: Micron Technology, Inc., Boise, ID (US)

(72) Inventors: Zhengbo Wang, Shanghai (CN); Wenjun Wu, Shanghai (CN); Ting Qiu, Shanghai (CN); Rui Zhuang, Shanghai (CN); Chaohui Liu, Shanghai (CN); Ming Ma, Shanghai (CN)

(21) Appl. No.: 19/213,848

(22) Filed: May 20, 2025

Related U.S. Application Data
(60) Provisional application No. 63/658,705, filed on Jun. 11, 2024.

(51) Int. Cl. G06F 12/06

(52) U.S. Cl. CPC G06F 12/063; G06F 2212/72

(57) ABSTRACT

Methods, systems, and devices for transmitting logical-to-physical (L2P) address mapping to a host system are described. A memory system may be configured to determine portions of an L2P mapping that are sequential, and transfer indications of respective starting addresses and a respective size of such sequential mappings. For example, a memory system may be configured to transmit an indication of a starting logical address, a corresponding starting physical address (e.g., a physical address mapped to the starting logical address), and a size of a sequential mapping from the starting logical and physical addresses. In some such examples, search techniques may be adapted at the memory system, at the host system, or both to facilitate address searching with the revised L2P mapping structure (e.g., to leverage indications of starting addresses and lengths of sequential portions), such as implementing aspects of a search tree or hash table.

### CROSS REFERENCE

The present Application for Patent claims priority to U.S. Patent Application No. 63/658,705 by Wang et al., entitled “TECHNIQUES FOR TRANSMITTING LOGICAL-TO-PHYSICAL ADDRESS MAPPING TO A HOST SYSTEM,” filed Jun. 11, 2024, which is assigned to the assignee hereof, and which is expressly incorporated by reference in its entirety herein.

### TECHNICAL FIELD

The following relates to one or more systems for memory, including techniques for transmitting logical-to-physical (L2P) address mapping to a host system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports techniques for transmitting L2P address mapping to a host system in accordance with examples as disclosed herein.

FIG. 2 shows an example of a system that supports techniques for transmitting L2P address mapping to a host system in accordance with examples as disclosed herein.

FIG. 3 shows an example of a hashtable that supports techniques for transmitting L2P address mapping to a host system in accordance with examples as disclosed herein.

FIG. 4 shows a block diagram of a memory system that supports techniques for transmitting L2P address mapping to a host system in accordance with examples as disclosed herein.

FIG. 5 shows a block diagram of a host system that supports techniques for transmitting L2P address mapping to a host system in accordance with examples as disclosed herein.

FIGS. 6 and 7 show flowcharts illustrating a method or methods that support techniques for transmitting L2P address mapping to a host system in accordance with examples as disclosed herein.

### DETAILED DESCRIPTION

Some memory systems may manage (e.g., store, update) a logical-to-physical (L2P) mapping, such as an L2P table, that provides mappings between logical addresses and physical addresses of the memory system (e.g., of one or more memory arrays of the memory system). In some examples, an L2P table may include entries having a fixed size (e.g., a fixed granularity, an underlying physical unit, an underlying logical unit), such as having entries for respective sets of one or more row of memory cells, for respective sets of one or more pages of memory cells, for respective sets of one or more blocks of memory cells, among other entry sizes. For some implementations of such memory systems, information of an L2P mapping may be communicated with (e.g., shared with, transferred to) a host system coupled with the memory system. However, communicating information of an L2P table with a fixed entry size may involve a relatively large data transfer to a host system (e.g., a relatively large quantity of indications, to indicate fixed-size entries of an entire L2P table or portion thereof), and may involve a relatively large amount of storage at the host system.

In accordance with examples as disclosed herein, a memory system may be configured to reduce an amount of information associated with communicating and storing an L2P mapping by determining portions of such a mapping that are sequentially-mapped, and transferring indications of respective starting addresses and a respective size of such sequential mappings. For example, a memory system may be configured to transmit, for at least some, if not all sequentially-mapped portions of an L2P table, an indication of a logical address (e.g., a starting logical address), a corresponding physical address (e.g., a starting physical address mapped with the starting logical address), and a size of sequential mapping associated with (e.g., starting from) the indicated logical and physical addresses. Thus, for data that is stored at a memory system in accordance with a relatively sequential mapping (e.g., with relatively few interruptions in a sequential mapping among multiple rows or pages), an overhead associated with communicating an L2P mapping from the memory system to a host system may be reduced and, in some examples, an amount of storage involved in maintaining the L2P mapping at the host system may be reduced. In some examples, search techniques may be adapted at the memory system, at the host system, or both to facilitate address searching with the revised L2P mapping structure (e.g., to leverage indications of starting addresses and lengths of sequential portions), such as implementing aspects of a search tree or hash table. Accordingly, these and other related techniques may improve the efficiency of communicating and storing L2P mapping of addresses of a memory system, among other benefits.

In addition to applicability in memory systems as described herein, techniques for techniques for transmitting logical-to-physical address mapping to a host system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing overhead associated with communicating an L2P mapping between a memory system and a host system, which may decrease processing or latency times and reduce storage otherwise associated with storing the L2P mapping, among other benefits.

Features of the disclosure are illustrated and described in the context of systems, devices, and circuits. Features of the disclosure are further illustrated and described in the context of hashtables, systems, and flowcharts.

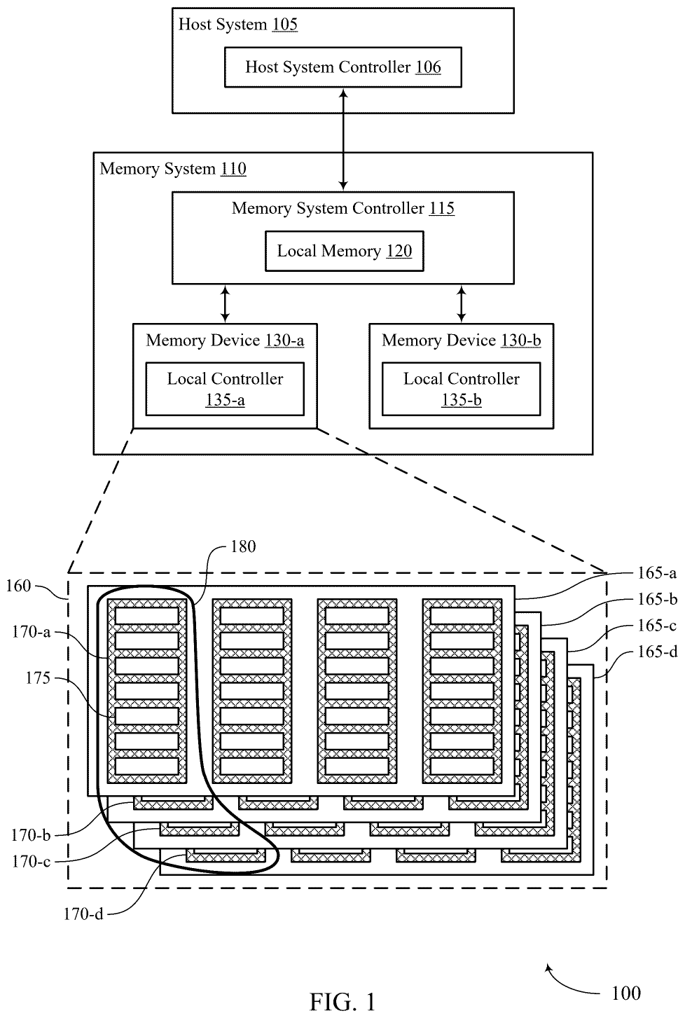

FIG. 1 shows an example of a system 100 that supports techniques for transmitting L2P address mapping to a host system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs), logical page addresses (LPAs)) associated with commands from the host system 105 and physical addresses (e.g., physical block addresses (PBAs), physical page addresses (PPAs)) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update an L2P mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has not been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

A memory system 110 may manage (e.g., store, update) a logical-to-physical (L2P) mapping, such as an L2P table, that provides mappings between logical addresses (e.g., addresses used for communicating and responding to commands from a host system 105) and physical addresses of the memory system 110 (e.g., addresses of one or more memory arrays, addresses of one or more memory devices 130, addresses of one or more dies 160). In some examples, an L2P table may include entries having a fixed size (e.g., a fixed granularity, an underlying physical unit, an underlying logical unit), such as having entries for respective sets of one or more row of memory cells, for respective sets of one or more pages 175, for respective sets of one or more blocks 170, among other entry sizes. In some examples, information of an L2P mapping may be communicated with (e.g., shared with, transferred to) a host system 105 coupled with the memory system 110, such as in a host performance boost (HPB) mode in which a host uses mapping information to support memory access operations. However, communicating information of an L2P table with a fixed entry size may involve a relatively large data transfer to a host system 105 (e.g., a relatively large quantity of indications, to indicate fixed-size entries of an entire L2P table or portion thereof), and may involve a relatively large amount of storage at the host system 105 (e.g., in a cache.

In accordance with examples as disclosed herein, a memory system 110 may be configured to reduce an amount of information associated with communicating and storing an L2P mapping by determining portions of such a mapping that are sequentially-mapped, and transferring (e.g., to a host system 105, to a host system controller 106) indications of respective starting addresses and a respective size of such sequential mappings. For example, a memory system 110 may be configured to transmit, for at least some, if not all sequentially-mapped portions of an L2P table, an indication of a logical address (e.g., a starting logical address), a corresponding physical address (e.g., a starting physical address mapped with the starting logical address), and a size of sequential mapping associated with (e.g., starting from) the indicated logical and physical addresses. Thus, for data that is stored at a memory system 110 in accordance with a relatively sequential mapping (e.g., with relatively few interruptions in a sequential mapping among multiple rows or pages), an overhead associated with communicating an L2P mapping from the memory system 110 to a host system 105 may be reduced and, in some examples, an amount of storage involved in maintaining the L2P mapping at the host system 105 may be reduced. In some examples, search techniques may be adapted at the memory system 110, at the host system 105, or both to facilitate address searching with the revised L2P mapping structure (e.g., to leverage indications of starting addresses and lengths of sequential portions), such as implementing aspects of a search tree or hash table. Accordingly, these and other related techniques may improve the efficiency of communicating and storing L2P mapping of addresses of a memory system 110, among other benefits.

The system 100 may include any quantity of non-transitory computer readable media that support techniques for transmitting L2P address mapping to a host system 105. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

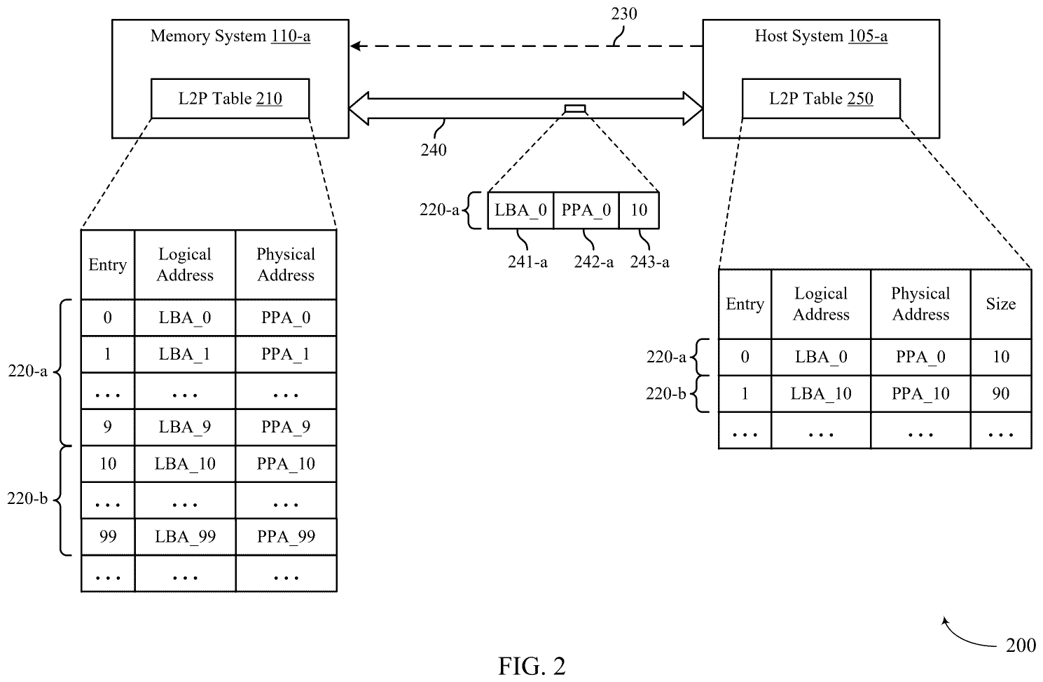

FIG. 2 shows an example of a system 200 that supports techniques for transmitting L2P address mapping to a host system in accordance with examples as disclosed herein. The system 200 may implement aspects or operations of a system 100. For example, the system 200 may include a host system 105-a and a memory system 110-a (e.g., coupled via one or more channels of a physical host interface), and the memory system 110-a may be configured to transmit at least a portion of an L2P mapping of the memory system 110-a (e.g., of one or more memory devices 130 of the memory system 110-a) to the host system 105-a (e.g., to support an HPB mode).

The memory system 110-a may include an L2P table 210, which may store an L2P mapping associated with one or more memory devices 130 (not shown) of the memory system 110-a. In some examples, an L2P table 210 may refer to an L2P mapping that is stored in non-volatile storage of the memory system 110-a, such as in non-volatile storage of a memory system controller 115 (e.g., of local memory 120) or of one or more memory devices 130 (e.g., NAND memory devices, NAND storage). In some examples, an L2P table 210 may refer to an L2P mapping that is stored in volatile storage of a memory system controller 115, such as in local memory 120 (e.g., SRAM storage), which, in some examples, may have been transferred from non-volatile storage of the memory system 110-a (e.g., of a memory device 130). In some examples, an L2P table 210 may refer to an L2P mapping that is cooperatively managed (e.g., by a memory system controller 115) among volatile storage and non-volatile storage, such that the L2P table 210 may be accessed and updated at least in part using relatively fast volatile storage, and also maintained at least in part using non-volatile storage in case of shut down, power loss, or other operation in which volatile storage does not maintain the L2P table 210 (e.g., for portions of the L2P table that may be relied upon after shutdown), among other implementations.

Entries of an L2P table 210 may include at least an indication of a logical address (e.g., an LBA, an LPA) and an indication of a physical address (e.g., a physical address that is mapped with the logical address, a PPA, a PBA) that are stored in a storage location of the memory system 110-a. For example, a first entry (e.g., entry 0) may map an LBA_0 with a PPA_0, a second entry (e.g., entry 1) may map an LBA_1 with a PPA_1, and so on through the entries of the L2P table 210. In some examples, the entry number itself (e.g., an entry index) may be stored in an L2P table 210 or may not be stored in an L2P table (e.g., with the entry numbers shown in FIG. 2 for illustrative purposes). In some examples, an L2P table may include other indications for each entry, such as a validity indication, an indication of a set of sequential data (e.g., whether data of multiple entries was written as part of a sequential write operation, whether data of multiple entries may be associated with a sequential read operation), or other indications applicable to a given entry.

In some examples, entries of an L2P table 210 may each be associated with a fixed size (e.g., a fixed quantity of mapped memory cells, a fixed amount of mapped storage, an underlying physical unit, an underlying logical unit). For example, an entry of an L2P table 210 may correspond to a row of memory cells, or a page 175, or a bank of memory cells, or some other underlying unit (e.g., as a fixed mapping granularity). In other words, in some examples, an L2P table 210 may have a fixed size of mapping between logical addresses of the memory system 110-a (e.g., used for communications between the host system 105-a and the memory system 110-a) and physical addresses of the memory system 110-a (e.g., associated with physical data locations of the memory system 110-a). Thus, an L2P table 210 may include a quantity of entries corresponding to a quantity of logical addresses or a quantity of physical addresses of the memory system 110 (e.g., up to a quantity of entries involved with mapping a storage capacity of the memory system 110).

In some examples, an L2P table 210 may include portions 220 that are associated with a sequential L2P mapping, for which logical addresses and physical addresses are sequential along a set of entries. For example, as illustrated, a portion 220-a may include entries numbered 0 through 9, for which logical addresses LBA_0 through LBA_9 are sequential (e.g., numerically consecutive, numerically adjacent, numerically successive) and physical addresses PPA_0 through PPA_9 are also sequential. Further, a portion 220-b may include entries numbered 10 through 99, for which logical addresses LBA_10 through LBA_99 are sequential and physical addresses PPA_10 through PPA_99 are also sequential. Thus, each of the portions 220-a and 220-b refer to entries having a sequential L2P mapping.

Within each portion 220, the associated data itself may be sequential, or may be non-sequential, while still being associated with the sequential L2P mapping of the portion 220. For example, the portion 220-a may refer to ten pages of a single sequential data set (e.g., of a sequential write, associated with a sequential read operation, a set of associated data), whereas the portion 220-b may refer to two or more sets of sequential data that are not related to each other (e.g., two or more separate sequential writes, sets of data for which a sequential read may be associated with a subset of less than all of the portion 220-b). Therefore, the sequential L2P mapping of a given portion 220 may be independent of (e.g., unrelated to) whether the data itself is sequential.

In various examples, addresses of adjacent portions 220 of an L2P table may be sequential or non-sequential. For example, referring to portions 220-a and 220-b, logical addresses LBA_9 and LBA_10 may be sequential or may be non-sequential, and physical addresses PPA_9 and PPA_10 may be sequential or may be non-sequential. In some examples, an L2P table 210 may be ordered such that all of the logical addresses are sequential along the entries of the L2P table, which may be implemented in a manner in which logical addresses of successive portions 220 are also sequential. Additionally, or alternatively, in some examples, portions 220 may be associated with a maximum size (e.g., a maximum quantity of entries), in which case logical and physical addresses of adjacent portions 220 may be consecutive if one or both of the adjacent portions 220 has size equal to the maximum size. In some other examples, logical addresses of adjacent portions 220 may be non-sequential and physical addresses of the adjacent portions 220 may be sequential, or logical addresses of adjacent portions 220 may be sequential and physical addresses of the adjacent portions 220 may be non-sequential, or logical addresses and physical addresses of adjacent portions 220 may both be non-sequential. In some implementations, a portion 220 may include a single entry (e.g., a single logical address and a single physical address) for cases in which the single logical address or the single physical address is not sequential with another mapped logical and physical address.

In some implementations, the memory system 110-a (e.g., a memory system controller 115) may be configured to transfer at least some of the L2P mapping information associated with the L2P table 210 to the host system 105-a (e.g., at least a portion of the L2P mapping information associated with one or more memory devices 130 of the memory system 110-a). For example, in an HPB mode or other mode, the host system 105-a (e.g., a host system controller 106) may use such mapping information to facilitate access operations performed on the memory system 110-a (e.g., for coordinating access commands transmitted to the memory system 110-a). However, transferring and maintaining each of the entries of an L2P table 210 individually may involve a relatively large information transfer from the memory system 110-a to the host system 105-a, or may involve a relatively large storage capacity of the host system 105-a, or both.

In accordance with examples as disclosed herein, the system 200 (e.g., the memory system 110-a, the host system 105-a, or both) may be configured to transfer indications of portions 220, which may involve a smaller transfer of information than indicating individual entries of an L2P table 210. For example, processing circuitry of the memory system 110-a (e.g., of a memory system controller 115, of one or more local controllers 135, or a combination thereof) may receive an indication to transmit (e.g., transfer, share, communicate) mapping information of an L2P table 210, which may be an indication to transfer all of the mapping information of the L2P table 210 or some portion of the mapping information of the L2P table 210 (e.g., mapping information of one or more storage partitions, mapping information of one or more memory devices 130, mapping information of an actively accessed portion of the memory system 110-a). In various examples, such an indication may be included in an indication 230 transmitted by the host system 105-a (e.g., a host system controller 106) and received by the memory system 110-a (e.g., an indication to enable an HPB mode), or may be an indication transmitted by another device and received by the memory system 110-a, or may be an indication stored at the memory system 110-a (e.g., in a mode register, which may have been written by the host system 105-a, programmed as part of a manufacturing or configuration operation, or otherwise written).

In response to the received indication to transmit L2P mapping information (e.g., associated with the L2P table 210), the memory system 110-a may transmit signaling 240 (e.g., mapping signaling, HPB signaling) that includes indications of one or more of the portions 220 of the L2P table, which may be received by the host system 105-a. For example, to indicate the portion 220-a, the memory system 110-a may transmit (e.g., as part of the signaling 240), an indication 241-a corresponding to a logical address of the portion 220-a (e.g., logical address LBA_0, a starting logical address), an indication 242-a corresponding to a physical address of the portion 220-a (e.g., physical address PPA_0, a starting physical address), and an indication 243-a corresponding to a size of the portion 220-a (e.g., a value of 10, which may correspond to 10 entries or 10 underlying units of the L2P table 210). To indicate the portion 220-b (not shown), the memory system 110-a may transmit an indication 241 corresponding to a logical address of the portion 220-b (e.g., logical address LBA_10), an indication 242 corresponding to a physical address of the portion 220-b (e.g., physical address PPA_10), and an indication 243 corresponding to a size of the portion 220-b (e.g., a value of 100). Accordingly, to indicate a given portion 220, the memory system 110-a may transmit three indications (e.g., an indication 241, an indication 242, and an indication 243), rather than separately indicating a logical address and a physical address for each of the entries (e.g., underlying units) of the portion 220, which may involve a relatively smaller transfer of information received by the host system 105-a. Such indications may be provided for any quantity of one or more portions 220, including indications for all of the portions 220 of an L2P table 210, or indications for a subset of fewer than all of the portions 220 of an L2P table 210.

The indications for signaling 240 (e.g., indications 241, 242, and 243) may be generated in accordance with various techniques. For example, the memory system 110-a (e.g., a memory system controller 115, one or more local controllers 135, or a combination thereof) may identify the portions 220 based at least in part on identifying respective sets of entries with sequential logical addresses and sequential physical addresses, and identifying starting addresses of such sets. In some examples, such sets may be subdivided into subsets, such as when a size of such a set exceeds a size that can be indicated by an indication 243 (e.g., corresponding to a maximum size of a portion 220). In some examples, such indications may be generated in response to receiving an indication to transfer L2P mapping information (e.g., in response to an indication 230). In some examples, a memory system 110-a may generate such indications proactively (e.g., without an indication to perform an L2P mapping transfer). For example, the memory system 110-a may store an L2P table 210 in non-volatile storage (e.g., of a memory device 130) and may generate such indications as part of reading the L2P table 210 from the non-volatile storage. In some examples, the memory system 110-a (e.g., a memory system controller 115) may store the indications in volatile memory (e.g., of local memory 120, of SRAM), which may be in addition to or as an alternative to storing the entries of the L2P table in the volatile memory.

In some examples, the host system 105-a (e.g., a host system controller 106) may store indications received in signaling 240 in an L2P table 250, which may include a single entry for each portion 220 (e.g., associated with a logical address corresponding to an indication 241, a physical address corresponding to an indication 242, and a size corresponding to an indication 243). Thus, for a given portion 220 or set of multiple portions 220, a storage allocated to storing the L2P table 250 at the host system 105-a may be smaller than a storage allocated to storing the L2P table 210 at the memory system 110-a. Further, the storage of the host system 105-a may be allocated for the L2P table 250 dynamically, which may be determined based on receiving the signaling 240 (e.g., as indications 241, 242, and 243 are received), thereby supporting at least some of the storage at the host system 105-a being available for other purposes, in some examples.

In some cases, an L2P mapping may change based on operations performed at the memory system 110-a. For example, the memory system 110-a may perform a memory management operation (e.g., to manage one or more aspects of operating memory cells of one or more memory devices 130 of the memory system 110-a), such as a garbage collection operation, a wear leveling operation, or another operation that changes one or more physical addresses at which given data is stored (e.g., for a given logical address). In some such examples, the memory system 110-a may update the L2P mapping stored at the memory system 110-a (e.g., updating an L2P table 210), and transmit one or more updates to the L2P mapping to the host system 105-a (e.g., via signaling 240 including an additional indication 241, 242, 243, or a combination thereof, corresponding to an updated mapping). In some examples, performing a memory management operation at the memory system 110-a may invalidate at least a portion of the L2P mapping stored at the host system 105-a (e.g., in a table 250), and the memory system 110-a may transmit an indication that at least a portion of the L2P mapping (e.g., from which prior signaling 240 was based, as previously stored at the memory system 110-a, as stored at the host system 105-a) is invalid, in which case the host system 105-a may update, add, or delete one or more entries of an L2P table 250.

In some examples, an invalidated L2P mapping may be associated with one or more portions 220, and invalidated entries (e.g., of an L2P table 210, of underlying units of entries of an L2P table 250) may be one or more initial entries of a portion 220, one or more middle entries of a portion 220 (e.g., between the first entry and a last entry of the portion 220), or one or more last entries of a portion 220. Accordingly, in some cases, a portion 220 may redefined based on identifying one or more new addresses (e.g., a starting logical address, a starting physical addresses, or both) for the portion 220, a new size for the portion 220, defining a new portion 220, deleting a portion 220, or a combination thereof. For example, the memory system 110-a may identify the first entry of the portion is invalid, and the memory system 110-a may redefine the first entry of the portion (e.g., with the original second entry, with a new mapping between a logical address and a physical address). In another example, the memory system 110-a may identify a middle entry of a portion 220 is invalid, and the memory system 110-a may redefine the size of the portion 220 (e.g., the size being from the first entry to the updated entry), and redefine the one or more starting addresses and the size of another portion 220 (e.g., as a new portion 220). In other examples, the memory system 110-a may identify that a last entry is invalid, and the memory system 110-a may redefine the size of the portion (e.g., the size being from the first entry to the updated entry). In some examples, the memory system 110-a may indicate an L2P mapping of a portion 220 to be deleted, which may include transmitting an indication 241 of the starting logical address, an indication 242 of the starting physical address, and an indication 243 of zero size. After redefining one or more portions 220, the memory system 110-a (e.g., the memory system controller 115) may transmit updated indications of the portion(s) to the host system 105-a (e.g., in additional signaling 240, in one or more indications 241, 242, 243, or a combination thereof).

In some examples, the memory system 110-a may receive updated mapping information from the host system 105-a (e.g., from a host system controller 106, via indications 241, 241, and 243 to the memory system 110-a, not shown). For example, the host system 105-a may transmit an indication that a portion 220 (e.g., one or more entries of an L2P table 210) is to be updated, such that the portion 220 or the L2P table 210 may include an updated mapping between a logical address and a physical address. In some examples, such an update may be associated with the host system 105-a invalidating data, such that the memory system 110-a may delete the invalidated data. Additionally, or alternatively, such an update may be associated with the host system 105-a performing memory management operations, in which case such an update may be associated with an indication (e.g., command) for the memory system 110-a to move data to a different physical location. In some examples, the host system 105-a may transmit an indication of one or more updated entries, which may correspond to one or more starting entries of a portion 220, one or more middle entries of a portion 220 (e.g., between the first entry and a last entry), or one or more ending entries of the portion 220. Accordingly, the host system 105-a may indicate an update to a portion 220 (e.g., with a new indication 243, with new indications 241 and 242, or a combination thereof), indicate a new portion 220 (e.g., with new indications 241, 242, and 243 when a portion 220 is divided into two or more smaller portions 220), or indicate a portion 220 to be deleted (e.g., with a zero-length indication 243), or any combination thereof.

In response to receiving the updated mapping information from the host system 105-a, the memory system 110-a may redefine one or more portions 220 of the L2P mapping associated with updated entries (e.g., in an L2P table 210). In some cases, redefining a portion 220 may include identifying (e.g., redefining) one or more new starting addresses of a portion 220, a size of the portion 220, or a combination thereof. For example, the host system 105-a may indicate that a first entry of a portion 220 is updated, and the memory system 110-a may redefine the first entry of the portion 220 (e.g., with the original second entry, with a new mapping between a logical address and a physical address). In another example, the host system 105-a may indicate a middle entry is updated, and the memory system 110-a may redefine the size of the portion 220, and redefine the one or more starting addresses and the size of another portion 220. In other examples, the host system 105 may indicate the last entry is updated, and the memory system 110-a may redefine the size of the portion 220. In various examples, such updates may be implemented to indications of portions 220 stored at the memory system 110-a, or entries of an L2P table 210, or both.

Implementing techniques for transmitting indications of portions 220 of an L2P table 210 having sequential L2P mapping may be associated with reduced overhead for communicating mapping information of an L2P table 210 from a memory system 110 to a host system 105-a. That is, transmitting indications (e.g., indications 241, 242, and 243) of the starting addresses and size of one or more portions 220 may enable the transmission to user fewer indications (e.g., fewer bits) of signaling (e.g., of signaling 240) than transmitting respective indications of each entry of an L2P table 210, which may reduce transmission latency and bandwidth consumption for transmitting mapping information of the L2P table 210. Additionally, storing such indications (e.g., of starting addresses and size of portions 220 having a sequential L2P mapping) in an L2P table 250 may reduce a size of storage involved in a host system 105 maintaining such information.

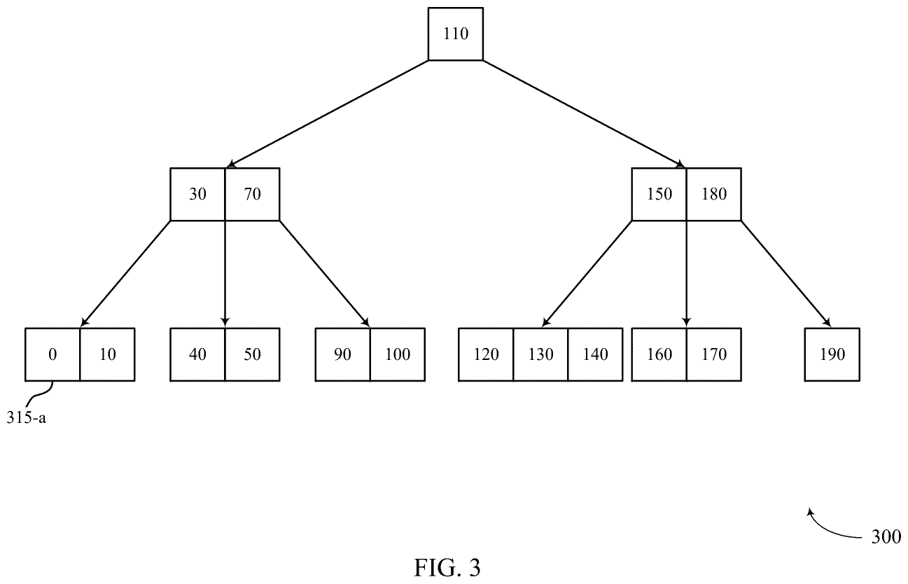

FIG. 3 shows an example of a hashtable 300 that supports techniques for transmitting L2P address mapping to a host system in accordance with examples as disclosed herein. The hashtable 300 may be implemented by one or more devices of a system 200, such as a memory system 110 (e.g., a memory system controller 115) or a host system 105 (e.g., a host system controller 106). For example, the hashtable 300 may be implemented by the system 200 to access portions of a L2P table 250 (e.g., at a host system 105) or a similar L2P table including indications of portions 220 (e.g., at a memory system 110). That is, the hashtable 300 may illustrate an organizational structure used by a host system 105 or a memory system 110 for accessing L2P mapping information organized in accordance with portions 220.

The hashtable 300 may include entries (e.g., hashes) that each correspond to an initial address (e.g., an initial logical address) of respective portions 220. The hashes may correspond to different granularities of the hashtable 300, such that the hashes may be organized according to a tree-like structure. That is, identifying a portion of an L2P mapping may include identifying an initial entry (e.g., an initial logical address), then identifying subsequent entries associated with the initial entry until locating a target logical address (e.g., a target entry, a target logical address between entries).

In some cases, a memory system 110 may use a hashtable 300 during an access operation commanded by a host system 105. For example, a host system 105 may transmit an indication requesting a portion of an L2P table 210 from a memory system 110 for use in an access operation. In an illustrative example, the indication may target a first entry 315-a, which may be associated with entries 0-9 of an L2P table 210 (e.g., LBA_0-LBA_9, PPA_0-PPA_9, a first portion 220). The memory system 110 may use the hashtable 300 to identify a respective portion 220. For example, the memory system 110 may identify a first entry (e.g., associated with an entry or logical address of 110) corresponding to a first tier of the hashtable 300, associated with a greatest granularity from which other entries may be identified. Then, the memory system 110 may identify a second entry (e.g., associated with an entry or logical address of 30) from the first entry corresponding to a second tier of the hashtable 300, associated with a lesser granularity from which other entries may be identified. Finally, the memory system 110 may identify a third entry (e.g., entry 315-a, associated with an entry or logical address of 0) from the second entry corresponding to a third tier of the hashtable 300, associated with a smallest granularity from which other entries may not be identified. The third entry may be associated with the portion 220-a of system 200, for example.

After identifying the entry associated with the portion 220 requested by the host system 105, the memory system 110 may transmit one or more indications of the portion 220 to the host system 105. That is, the memory system 110 may transmit an indication of one or more starting addresses (e.g., a starting logical address and a starting physical address, indications 241 and 242) associated with the portion 220, and a size of the portion 220 (e.g., a quantity of entries of the portion, a quantity of logical addresses of the portion, a quantity of physical addresses of the portion, an indication 243). For example, referring to the example of portion 220-a, the memory system 110 may transmit indications of LBA_0, PPA_0, and size 10 based on identifying the first portion 220-a from the hashtable 300. After receiving the one or more indications of the portion from the memory system 110, the host system 105 may access the one or more addresses of the portion 220-a using the one or more indications of the portion 220-a.

In some cases, the memory system 110 may use the hashtable 300 to update one or more portions 220 (e.g., of an L2P table 210). For example, the memory system 110 may receive an indication of one or more updated mappings of the L2P table 210, or the memory system 110 may identify one or more invalidated mappings of the L2P table 210. In these and other examples, the memory system 110 may use the hashtable 300 to update (e.g., replace) the updated or invalidated mapping. For example, the entry 0 may be identified for update, and the memory system 110 may identify the hashes associated with entry 0, then update entry 0 accordingly.

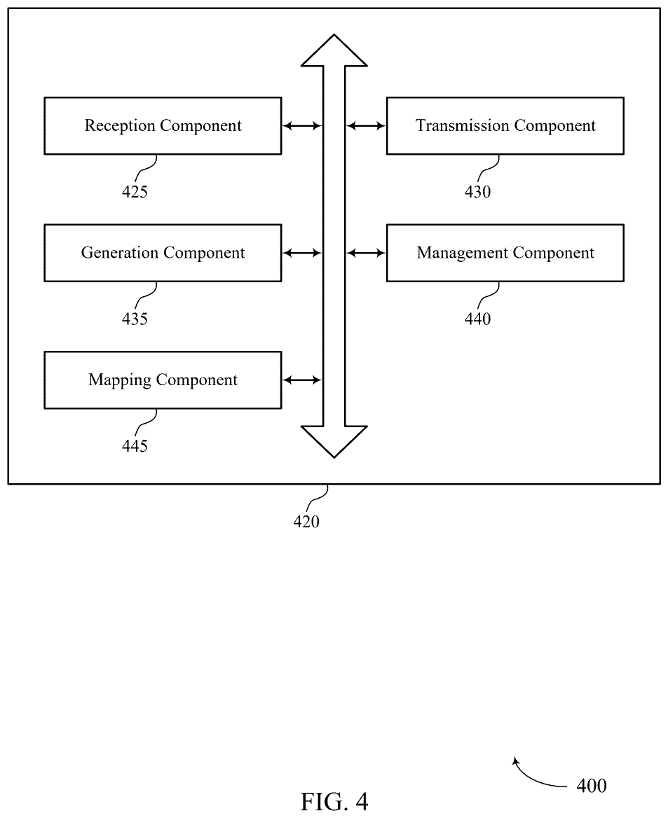

FIG. 4 shows a block diagram 400 of a memory system 420 that supports techniques for transmitting L2P address mapping to a host system in accordance with examples as disclosed herein. The memory system 420 may be an example of aspects of a memory system as described with reference to FIGS. 1 through 3. The memory system 420, or various components thereof, may be an example of means for performing various aspects of techniques for transmitting L2P address mapping to a host system as described herein. For example, the memory system 420 may include a reception component 425, a transmission component 430, a generation component 435, a management component 440, a mapping component 445, or any combination thereof. Each of these components, or components of subcomponents thereof (e.g., one or more processors, one or more memories), may communicate, directly or indirectly, with one another (e.g., via one or more buses).

The reception component 425 may be configured as or otherwise support a means for receiving, at the memory system 420, a first indication to transmit information associated with an L2P mapping stored at the memory system 420. The transmission component 430 may be configured as or otherwise support a means for transmitting, from the memory system 420 based at least in part on receiving the first indication, a second indication corresponding to a logical address of a portion of the L2P mapping, a third indication corresponding to a physical address of the portion of the L2P mapping, and a fourth indication corresponding to a size of the portion of the L2P mapping.

In some examples, the portion of the L2P mapping is associated with addresses of the memory system 420 having a sequential L2P mapping.

In some examples, the generation component 435 may be configured as or otherwise support a means for generating the first indication, the second indication, and the third indication based at least in part on an L2P table of the memory system 420 having a fixed size of mapping between logical addresses and physical addresses.

In some examples, the management component 440 may be configured as or otherwise support a means for performing a memory management operation at the memory system 420. In some examples, the mapping component 445 may be configured as or otherwise support a means for updating the L2P mapping stored at the memory system 420 based at least in part on performing the memory management operation. In some examples, the transmission component 430 may be configured as or otherwise support a means for transmitting, from the memory system 420 based at least in part on updating the L2P mapping, a fifth indication corresponding to a second logical address of a portion of the updated L2P mapping, a sixth indication corresponding to a second physical address of the portion of the updated L2P mapping, and a seventh indication corresponding a second size of the portion of the updated L2P mapping.

In some examples, the fifth indication corresponds to the second logical address being equal to the logical address, the sixth indication corresponds to the second physical address being different than the physical address, and the seventh indication corresponds to the second size being equal to the size.

In some examples, the fifth indication corresponds to the second logical address being equal to the logical address, the sixth indication corresponds to the second physical address being equal to the physical address, and the seventh indication corresponds to the second size being different than the size.

In some examples, the management component 440 may be configured as or otherwise support a means for performing a memory management operation at the memory system 420. In some examples, the mapping component 445 may be configured as or otherwise support a means for updating the L2P mapping stored at the memory system 420 based at least in part on performing the memory management operation. In some examples, the transmission component 430 may be configured as or otherwise support a means for transmitting, from the memory system 420 based at least in part on updating the L2P mapping, an indication that the portion of the L2P mapping is invalid.

In some examples, the reception component 425 may be configured as or otherwise support a means for receiving an indication to update the L2P mapping stored at the memory system 420. In some examples, the mapping component 445 may be configured as or otherwise support a means for updating the L2P mapping stored at the memory system 420 based at least in part on receiving the indication to update the L2P mapping.

In some examples, to receive the indication to update the L2P mapping stored at the memory system 420, the reception component 425 may be configured as or otherwise support a means for receiving a fifth indication corresponding to a second logical address of a portion of an updated L2P mapping, a sixth indication corresponding to a second physical address of the portion of the updated L2P mapping, and a seventh indication corresponding a second size of the portion of the updated L2P mapping.

In some examples, to receive the indication to update the L2P mapping stored at the memory system 420, the reception component 425 may be configured as or otherwise support a means for receiving an indication that the portion of the L2P mapping is invalid.

In some examples, the L2P mapping includes a plurality of portions including the portion. In some examples, the transmitting includes transmitting, for each portion of the plurality of portions, a respective second indication corresponding to a logical address of the each portion, a respective third indication corresponding to a physical address of the each portion, and a respective fourth indication corresponding a size of the each portion.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

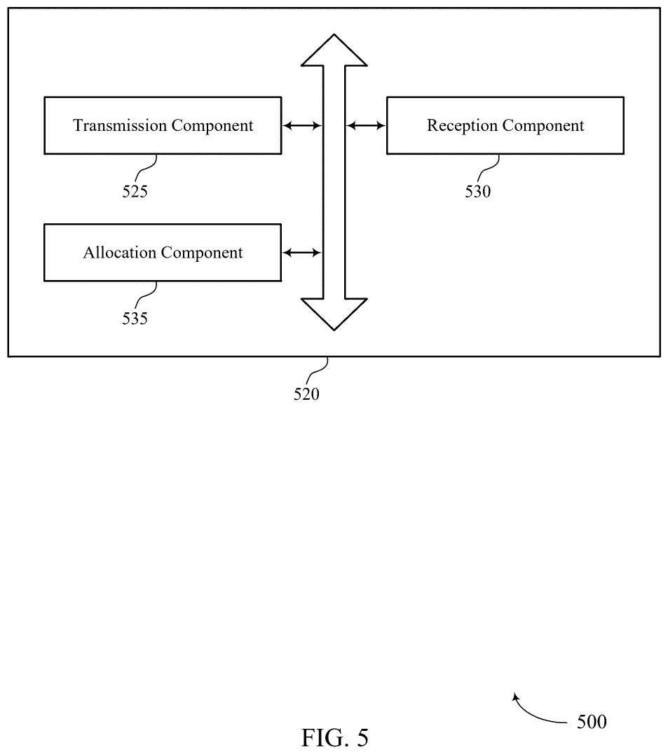

FIG. 5 shows a block diagram 500 of a host system 520 that supports techniques for transmitting L2P address mapping to a host system in accordance with examples as disclosed herein. The host system 520 may be an example of aspects of a host system as described with reference to FIGS. 1 through 3. The host system 520, or various components thereof, may be an example of means for performing various aspects of techniques for transmitting L2P address mapping to a host system as described herein. For example, the host system 520 may include a transmission component 525, a reception component 530, an allocation component 535, or any combination thereof. Each of these components, or components of subcomponents thereof (e.g., one or more processors, one or more memories), may communicate, directly or indirectly, with one another (e.g., via one or more buses).

The transmission component 525 may be configured as or otherwise support a means for transmitting a first indication for a memory system to transmit information associated with a L2P mapping to the host system 520. The reception component 530 may be configured as or otherwise support a means for receiving, based at least in part on transmitting the first indication, a second indication corresponding to a logical address of a portion of the L2P mapping, a third indication corresponding to a physical address of the portion of the L2P mapping, and a fourth indication corresponding to a size of the portion of the L2P mapping.

In some examples, the portion of the L2P mapping is associated with addresses of the L2P mapping having a sequential L2P mapping.

In some examples, the reception component 530 may be configured as or otherwise support a means for receiving, based at least in part on an update to the L2P mapping, a fifth indication corresponding to a second logical address of a portion of the updated L2P mapping, a sixth indication corresponding to a second physical address of the portion of the updated L2P mapping, and a seventh indication corresponding a second size of the portion of the updated L2P mapping.

In some examples, the fifth indication corresponds to the second logical address being equal to the logical address, the sixth indication corresponds to the second physical address being different than the physical address, and the seventh indication corresponds to the second size being equal to the size.

In some examples, the fifth indication corresponds to the second logical address being equal to the logical address, the sixth indication corresponds to the second physical address being equal to the physical address, and the seventh indication corresponds to the second size being different than the size.

In some examples, the reception component 530 may be configured as or otherwise support a means for receiving, based at least in part on an update to the L2P mapping, an indication that the portion of the L2P mapping is invalid.

In some examples, the transmission component 525 may be configured as or otherwise support a means for transmitting an indication to update the L2P mapping at the memory system, where the indication includes a fifth indication corresponding to a second logical address of a portion of an updated L2P mapping, a sixth indication corresponding to a second physical address of the portion of the updated L2P mapping, and a seventh indication corresponding a second size of the portion of the updated L2P mapping.

In some examples, the L2P mapping includes a plurality of portions including the portion. In some examples, the receiving includes receiving, for each portion of the plurality of portions. In some examples, a respective second indication corresponding to a logical address of the each portion. In some examples, a respective third indication corresponding to a physical address of the each portion. In some examples, a respective fourth indication corresponding a size of the each portion.

In some examples, the allocation component 535 may be configured as or otherwise support a means for allocating a storage location of the host system for storing the information associated with the L2P mapping based at least in part on receiving the second indication, the third indication, and the fourth indication.

In some examples, the described functionality of the host system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 520, or various components thereof, may be implemented at least in part by instructions (e.g., stored in memory, non-transitory computer-readable medium) executable by such at least one processor.

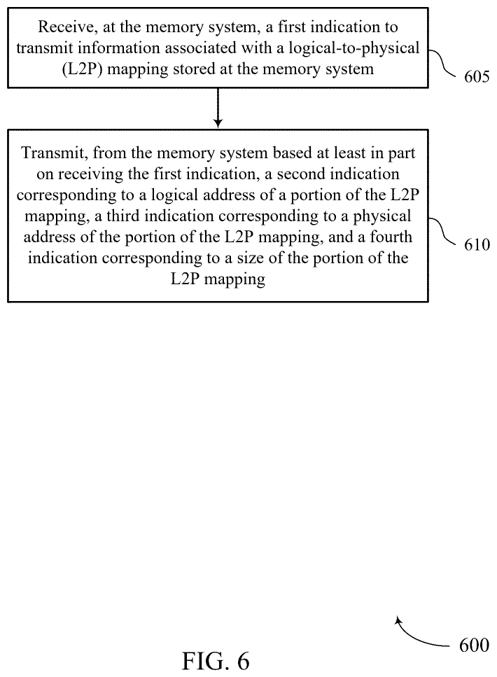

FIG. 6 shows a flowchart illustrating a method 600 that supports techniques for transmitting L2P address mapping to a host system in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving, at the memory system, a first indication to transmit information associated with a L2P mapping stored at the memory system. In some examples, aspects of the operations of 605 may be performed by a reception component 425 as described with reference to FIG. 4.

At 610, the method may include transmitting, from the memory system based at least in part on receiving the first indication, a second indication corresponding to a logical address of a portion of the L2P mapping, a third indication corresponding to a physical address of the portion of the L2P mapping, and a fourth indication corresponding to a size of the portion of the L2P mapping. In some examples, aspects of the operations of 610 may be performed by a transmission component 430 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving, at the memory system, a first indication to transmit information associated with an L2P mapping stored at the memory system and transmitting, from the memory system based at least in part on receiving the first indication, a second indication corresponding to a logical address of a portion of the L2P mapping, a third indication corresponding to a physical address of the portion of the L2P mapping, and a fourth indication corresponding to a size of the portion of the L2P mapping.
Aspect 2: The method, apparatus, or non-transitory computer-readable medium of aspect 1, where the portion of the L2P mapping is associated with addresses of the memory system having a sequential L2P mapping.
Aspect 3: The method, apparatus, or non-transitory computer-readable medium of any of aspects 1 through 2, further including operations, features, circuitry, logic, means, or instructions, or any combination thereof for generating the first indication, the second indication, and the third indication based at least in part on an L2P table of the memory system having a fixed size of mapping between logical addresses and physical addresses.
Aspect 4: The method, apparatus, or non-transitory computer-readable medium of any of aspects 1 through 3, further including operations, features, circuitry, logic, means, or instructions, or any combination thereof for performing a memory management operation at the memory system; updating the L2P mapping stored at the memory system based at least in part on performing the memory management operation; and transmitting, from the memory system based at least in part on updating the L2P mapping, a fifth indication corresponding to a second logical address of a portion of the updated L2P mapping, a sixth indication corresponding to a second physical address of the portion of the updated L2P mapping, and a seventh indication corresponding a second size of the portion of the updated L2P mapping.
Aspect 5: The method, apparatus, or non-transitory computer-readable medium of aspect 4, where the fifth indication corresponds to the second logical address being equal to the logical address, the sixth indication corresponds to the second physical address being different than the physical address, and the seventh indication corresponds to the second size being equal to the size.
Aspect 6: The method, apparatus, or non-transitory computer-readable medium of any of aspects 4 through 5, where the fifth indication corresponds to the second logical address being equal to the logical address, the sixth indication corresponds to the second physical address being equal to the physical address, and the seventh indication corresponds to the second size being different than the size.
Aspect 7: The method, apparatus, or non-transitory computer-readable medium of any of aspects 1 through 6, further including operations, features, circuitry, logic, means, or instructions, or any combination thereof for performing a memory management operation at the memory system; updating the L2P mapping stored at the memory system based at least in part on performing the memory management operation; and transmitting, from the memory system based at least in part on updating the L2P mapping, an indication that the portion of the L2P mapping is invalid.
Aspect 8: The method, apparatus, or non-transitory computer-readable medium of any of aspects 1 through 7, further including operations, features, circuitry, logic, means, or instructions, or any combination thereof for receiving an indication to update the L2P mapping stored at the memory system and updating the L2P mapping stored at the memory system based at least in part on receiving the indication to update the L2P mapping.
Aspect 9: The method, apparatus, or non-transitory computer-readable medium of aspect 8, where receiving the indication to update the L2P mapping stored at the memory system includes operations, features, circuitry, logic, means, or instructions, or any combination thereof for receiving a fifth indication corresponding to a second logical address of a portion of an updated L2P mapping, a sixth indication corresponding to a second physical address of the portion of the updated L2P mapping, and a seventh indication corresponding a second size of the portion of the updated L2P mapping.
Aspect 10: The method, apparatus, or non-transitory computer-readable medium of any of aspects 8 through 9, where receiving the indication to update the L2P mapping stored at the memory system includes operations, features, circuitry, logic, means, or instructions, or any combination thereof for receiving an indication that the portion of the L2P mapping is invalid.
Aspect 11: The method, apparatus, or non-transitory computer-readable medium of any of aspects 1 through 10, where the L2P mapping includes a plurality of portions including the portion, and the transmitting includes transmitting, for each portion of the plurality of portions, a respective second indication corresponding to a logical address of the each portion, a respective third indication corresponding to a physical address of the each portion, and a respective fourth indication corresponding a size of the each portion.

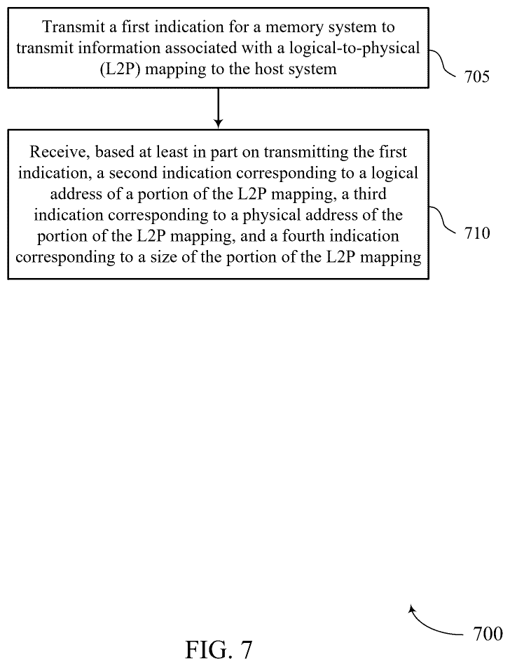

FIG. 7 shows a flowchart illustrating a method 700 that supports techniques for transmitting L2P address mapping to a host system in accordance with examples as disclosed herein. The operations of method 700 may be implemented by a host system or its components as described herein. For example, the operations of method 700 may be performed by a host system as described with reference to FIGS. 1 through 3 and 5. In some examples, a host system may execute a set of instructions to control the functional elements of the device to perform the described functions. Additionally, or alternatively, the host system may perform aspects of the described functions using special-purpose hardware.

At 705, the method may include transmitting a first indication for a memory system to transmit information associated with an L2P mapping to the host system. In some examples, aspects of the operations of 705 may be performed by a transmission component 525 as described with reference to FIG. 5.

At 710, the method may include receiving, based at least in part on transmitting the first indication, a second indication corresponding to a logical address of a portion of the L2P mapping, a third indication corresponding to a physical address of the portion of the L2P mapping, and a fourth indication corresponding to a size of the portion of the L2P mapping. In some examples, aspects of the operations of 710 may be performed by a reception component 530 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:
Aspect 12: A method, apparatus, or non-transitory computer-readable medium including operations, features, circuitry, logic, means, or instructions, or any combination thereof for transmitting a first indication for a memory system to transmit information associated with an L2P mapping to the host system and receiving, based at least in part on transmitting the first indication, a second indication corresponding to a logical address of a portion of the L2P mapping, a third indication corresponding to a physical address of the portion of the L2P mapping, and a fourth indication corresponding to a size of the portion of the L2P mapping.
Aspect 13: The method, apparatus, or non-transitory computer-readable medium of aspect 12, where the portion of the L2P mapping is associated with addresses of the L2P mapping having a sequential L2P mapping.
Aspect 14: The method, apparatus, or non-transitory computer-readable medium of any of aspects 12 through 13, further including operations, features, circuitry, logic, means, or instructions, or any combination thereof for receiving, based at least in part on an update to the L2P mapping, a fifth indication corresponding to a second logical address of a portion of the updated L2P mapping, a sixth indication corresponding to a second physical address of the portion of the updated L2P mapping, and a seventh indication corresponding a second size of the portion of the updated L2P mapping.
Aspect 15: The method, apparatus, or non-transitory computer-readable medium of aspect 14, where the fifth indication corresponds to the second logical address being equal to the logical address, the sixth indication corresponds to the second physical address being different than the physical address, and the seventh indication corresponds to the second size being equal to the size.
Aspect 16: The method, apparatus, or non-transitory computer-readable medium of any of aspects 14 through 15, where the fifth indication corresponds to the second logical address being equal to the logical address, the sixth indication corresponds to the second physical address being equal to the physical address, and the seventh indication corresponds to the second size being different than the size.
Aspect 17: The method, apparatus, or non-transitory computer-readable medium of any of aspects 12 through 16, further including operations, features, circuitry, logic, means, or instructions, or any combination thereof for receiving, based at least in part on an update to the L2P mapping, an indication that the portion of the L2P mapping is invalid.
Aspect 18: The method, apparatus, or non-transitory computer-readable medium of any of aspects 12 through 17, further including operations, features, circuitry, logic, means, or instructions, or any combination thereof for transmitting an indication to update the L2P mapping at the memory system, where the indication includes a fifth indication corresponding to a second logical address of a portion of an updated L2P mapping, a sixth indication corresponding to a second physical address of the portion of the updated L2P mapping, and a seventh indication corresponding a second size of the portion of the updated L2P mapping.
Aspect 19: The method, apparatus, or non-transitory computer-readable medium of any of aspects 12 through 18, where the L2P mapping includes a plurality of portions including the portion; the receiving includes receiving, for each portion of the plurality of portions; a respective second indication corresponding to a logical address of the each portion; a respective third indication corresponding to a physical address of the each portion; and a respective fourth indication corresponding a size of the each portion.
Aspect 20: The method, apparatus, or non-transitory computer-readable medium of any of aspects 12 through 19, further including operations, features, circuitry, logic, means, or instructions, or any combination thereof for allocating a storage location of the host system for storing the information associated with the L2P mapping based at least in part on receiving the second indication, the third indication, and the fourth indication.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a first indication to transmit information associated with a logical-to-physical (L2P) mapping stored at the memory system; and
transmit, based at least in part on receiving the first indication, a second indication corresponding to a logical address of a portion of the L2P mapping, a third indication corresponding to a physical address of the portion of the L2P mapping, and a fourth indication corresponding to a size of the portion of the L2P mapping.

2. The memory system of claim 1, wherein the portion of the L2P mapping is associated with addresses of the memory system having a sequential L2P mapping.

3. The memory system of claim 1, wherein the processing circuitry is further configured to cause the memory system to:
generate the first indication, the second indication, and the third indication based at least in part on an L2P table of the memory system having a fixed size of mapping between logical addresses and physical addresses.

4. The memory system of claim 1, wherein the processing circuitry is further configured to cause the memory system to:
perform a memory management operation at the memory system;
update the L2P mapping stored at the memory system based at least in part on performing the memory management operation; and
transmit, from the memory system based at least in part on updating the L2P mapping, a fifth indication corresponding to a second logical address of a portion of the updated L2P mapping, a sixth indication corresponding to a second physical address of the portion of the updated L2P mapping, and a seventh indication corresponding a second size of the portion of the updated L2P mapping.

5. The memory system of claim 4, wherein the fifth indication corresponds to the second logical address being equal to the logical address, the sixth indication corresponds to the second physical address being different than the physical address, and the seventh indication corresponds to the second size being equal to the size.

6. The memory system of claim 4, wherein the fifth indication corresponds to the second logical address being equal to the logical address, the sixth indication corresponds to the second physical address being equal to the physical address, and the seventh indication corresponds to the second size being different than the size.

7. The memory system of claim 1, wherein the processing circuitry is further configured to cause the memory system to:
perform a memory management operation at the memory system;
update the L2P mapping stored at the memory system based at least in part on performing the memory management operation; and
transmit, from the memory system based at least in part on updating the L2P mapping, an indication that the portion of the L2P mapping is invalid.

8. The memory system of claim 1, wherein the processing circuitry is further configured to cause the memory system to:
receive an indication to update the L2P mapping stored at the memory system; and
update the L2P mapping stored at the memory system based at least in part on receiving the indication to update the L2P mapping.

9. The memory system of claim 8, wherein to receive the indication to update the L2P mapping stored at the memory system, the processing circuitry is configured to cause the memory system to:
receive a fifth indication corresponding to a second logical address of a portion of an updated L2P mapping, a sixth indication corresponding to a second physical address of the portion of the updated L2P mapping, and a seventh indication corresponding a second size of the portion of the updated L2P mapping.

10. The memory system of claim 8, wherein to receive the indication to update the L2P mapping stored at the memory system, the processing circuitry is configured to cause the memory system to:
receive an indication that the portion of the L2P mapping is invalid.

11. The memory system of claim 1, wherein:
the L2P mapping comprises a plurality of portions including the portion; and
the processing circuitry is further configured to cause the memory system to transmit, for each portion of the plurality of portions:
a respective second indication corresponding to a logical address of the each portion;
a respective third indication corresponding to a physical address of the each portion; and
a respective fourth indication corresponding a size of the each portion.

12. A host system, comprising:
one or more interfaces comprising one or more signal paths operable for communications with one or more memory systems; and
processing circuitry coupled with the one or more interfaces and configured to cause the host system to:
transmit a first indication for a memory system to transmit information associated with a logical-to-physical (L2P) mapping to the host system; and
receive, based at least in part on transmitting the first indication, a second indication corresponding to a logical address of a portion of the L2P mapping, a third indication corresponding to a physical address of the portion of the L2P mapping, and a fourth indication corresponding to a size of the portion of the L2P mapping.

13. The host system of claim 12, wherein the portion of the L2P mapping is associated with addresses of the L2P mapping having a sequential L2P mapping.

14. The host system of claim 12, wherein the processing circuitry is further configured to cause the host system to:
receive, based at least in part on an update to the L2P mapping, a fifth indication corresponding to a second logical address of a portion of the updated L2P mapping, a sixth indication corresponding to a second physical address of the portion of the updated L2P mapping, and a seventh indication corresponding a second size of the portion of the updated L2P mapping.

15. The host system of claim 14, wherein the fifth indication corresponds to the second logical address being equal to the logical address, the sixth indication corresponds to the second physical address being different than the physical address, and the seventh indication corresponds to the second size being equal to the size.

16. The host system of claim 14, wherein the fifth indication corresponds to the second logical address being equal to the logical address, the sixth indication corresponds to the second physical address being equal to the physical address, and the seventh indication corresponds to the second size being different than the size.

17. The host system of claim 12, wherein the processing circuitry is further configured to cause the host system to:
receive, based at least in part on an update to the L2P mapping, an indication that the portion of the L2P mapping is invalid.

18. The host system of claim 12, wherein the processing circuitry is further configured to cause the host system to:
transmit an indication to update the L2P mapping at the memory system, wherein the indication comprises a fifth indication corresponding to a second logical address of a portion of an updated L2P mapping, a sixth indication corresponding to a second physical address of the portion of the updated L2P mapping, and a seventh indication corresponding a second size of the portion of the updated L2P mapping.

19. The host system of claim 12, wherein:
the L2P mapping comprises a plurality of portions including the portion; and
the receiving comprises receiving, for each portion of the plurality of portions:
a respective second indication corresponding to a logical address of the each portion;
a respective third indication corresponding to a physical address of the each portion; and
a respective fourth indication corresponding a size of the each portion.

20. The host system of claim 12, wherein the processing circuitry is further configured to cause the host system to:
allocate a storage location of the host system for storing the information associated with the L2P mapping based at least in part on receiving the second indication, the third indication, and the fourth indication.

21. A non-transitory computer-readable medium storing code, the code comprising instructions executable by one or more processors to:
receive, at a memory system, a first indication to transmit information associated with a logical-to-physical (L2P) mapping stored at the memory system; and
transmit, from the memory system based at least in part on receiving the first indication, a second indication corresponding to a logical address of a portion of the L2P mapping, a third indication corresponding to a physical address of the portion of the L2P mapping, and a fourth indication corresponding to a size of the portion of the L2P mapping.

22. The non-transitory computer-readable medium of claim 21, wherein the portion of the L2P mapping is associated with addresses of the memory system having a sequential logical-to-physical mapping.

23. The non-transitory computer-readable medium of claim 21, wherein the instructions are further executable by the one or more processors to:
perform a memory management operation at the memory system;
update the L2P mapping stored at the memory system based at least in part on performing the memory management operation; and
transmit, from the memory system based at least in part on updating the L2P mapping, a fifth indication corresponding to a second logical address of a portion of the updated L2P mapping, a sixth indication corresponding to a second physical address of the portion of the updated L2P mapping, and a seventh indication corresponding a second size of the portion of the updated L2P mapping.

24. A non-transitory computer-readable medium storing code, the code comprising instructions executable by one or more processors to:
transmit a first indication for a memory system to transmit information associated with a logical-to-physical (L2P) mapping to a host system; and
receive, based at least in part on transmitting the first indication, a second indication corresponding to a logical address of a portion of the L2P mapping, a third indication corresponding to a physical address of the portion of the L2P mapping, and a fourth indication corresponding to a size of the portion of the L2P mapping.

25. The non-transitory computer-readable medium of claim 24, wherein the portion of the L2P mapping is associated with addresses of the L2P mapping having a sequential logical-to-physical mapping.

26. The non-transitory computer-readable medium of claim 24, wherein the instructions are further executable by the one or more processors to:
receive, based at least in part on an update to the L2P mapping, a fifth indication corresponding to a second logical address of a portion of the updated L2P mapping, a sixth indication corresponding to a second physical address of the portion of the updated L2P mapping, and a seventh indication corresponding a second size of the portion of the updated L2P mapping.
